(19) United States
(12) Patent Application Publication
(10) Pub. No.: US 2025/0379661 A1
(43) Pub. Date: Dec. 11, 2025

(54) Quantum Collapse Alpha Communications (QCAC): A Secure Non-Encrypted Faster-Than-Light Communications Gateway

(71) Applicant: Philip Hardy, Maricopa, AZ (US)

(72) Inventor: Philip Hardy, Maricopa, AZ (US)

(21) Appl. No.: 19/211,167

(22) Filed: May 17, 2025

(51) Int. Cl. H04B 10/70

(52) U.S. Cl. CPC H04B 10/70

(57) ABSTRACT

A method for quantum communication using the intentional collapse of entangled quantum states as the signaling mechanism. Pre-distributed entangled particles or entities are assigned to symbolic queues at communication nodes. Messages are encoded in the sequence, position, or timing of collapse events, eliminating classical channel dependency. Supports binary and symbolic queues, emergent entangled media types, and secure communication over arbitrary distances.

### FIELD OF THE INVENTION

This invention relates to the field of quantum communications, specifically to a method of transmitting information using the intentional collapse of entangled quantum states as the signal itself, eliminating the need for a classical communication channel.

### BACKGROUND OF THE INVENTION

Conventional quantum communication methods depend on quantum key distribution or teleportation schemes, which still require classical channels to complete the data exchange process. The novel concept introduced herein eliminates classical transmission pathways entirely by using quantum state collapse itself as the message signal. No known system or method currently applies entangled particle collapse as a direct and exclusive signaling medium. This invention introduces a communications architecture based entirely on this principle.

### SUMMARY OF THE INVENTION

The invention utilizes entangled quantum entities distributed between two or more locations. When one of the entangled entities is collapsed intentionally via a triggering input at the sender node, the corresponding entangled state at the receiver node also collapses. This event is detected and interpreted as a meaningful signal. A sequence or pattern of such collapses constitutes a message. Message encoding can use a simple binary model, Morse code, alphabetic queues, or any symbolic system supported by timing, pattern recognition, or indexed queues at each node.

### BRIEF DESCRIPTION OF THE DRAWINGS

FIG. 1: Schematic layout of entangled communication queues. (Placeholder only—image provided separately in PNG/PDF formats per USPTO rules.)

FIG. 1: Conceptual schematic showing entangled particle pairs, node queues, collapse detection, and message reconstruction.

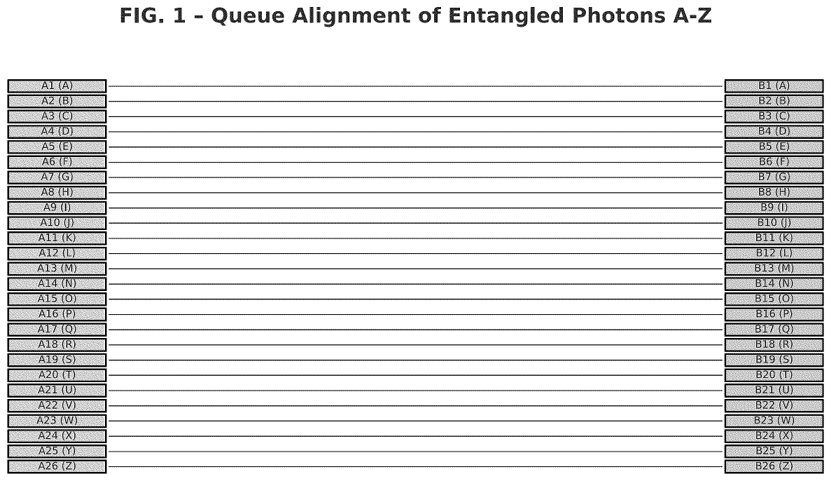

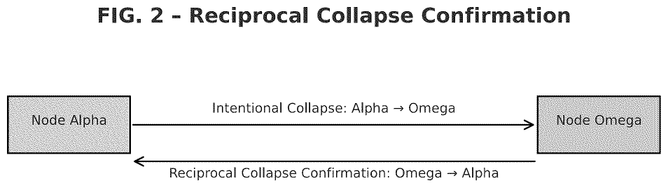

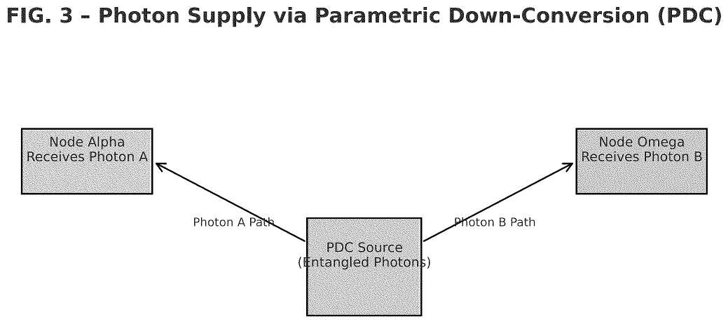

### DETAILED DESCRIPTION OF THE INVENTION

6.1 The QCAC system consists of quantum entangled media pre-distributed to remote nodes.
6.2 Each node includes a queue of entangled entities representing message channels or symbolic constructs.
6.3 This may include binary queues, alphanumeric character queues, or application-specific auxiliary queues.
6.4 Each queue position is linked to an entangled particle or field capable of state collapse detection.
6.5 When a message is to be sent, the system encodes it as a collapse sequence using the pre-assigned queue.
6.6 The receiver node detects the collapse events in the corresponding queue positions and reconstructs the message.
6.7 Entangled entities include, but are not limited to: photons, phonons, electrons, protons, neutrons, atomic nuclei, entire atoms, Cooper pairs, polaritons, magnons, plasmons, excitons, positrons, neutrinos, muons, anyon-like quasiparticles, skyrmions, quantum dots, Bose-Einstein condensates, spin-ensemble clouds, probability clouds, qubits, and synthetic quasiparticle states in metamaterials or engineered quantum lattices.
6.8 The system supports cryogenic containment for coherence preservation, as well as message buffering, error-resistant signaling, and various encoding schemes ranging from binary collapse sequences to multi-symbol collapse arrays.
6.9 It includes minimal queuing (1 or 2 bit) and extended symbolic queues (e.g., A-Z) for higher complexity transmissions.

1. A method for quantum communication comprising utilizing entangled quantum entities pre-distributed across two or more remote nodes, initiating the collapse of one or more of said entangled quantum entities at a first node in response to an intentional signaling event, detecting the resulting collapse event at a second node, and using the pattern, position, or timing of such collapse events to transmit information without employing any classical communication channel.

2. The method of claim 1, wherein said entangled quantum entities are selected from the group consisting of photons, phonons, electrons, protons, neutrons, atomic nuclei, atoms, positrons, neutrinos, muons, Cooper pairs, polaritons, plasmons, magnons, excitons, anyons, quasiparticles, synthetic quantum lattice states, quantum dots, Bose-Einstein condensates, probability clouds, spin-ensemble states, qubits, and emergent or engineered quantum-entanglement-supporting constructs.

3. The method of claim 1, wherein the signaling event is triggered by user input, sensor input, biometric input, system logic, or environmental stimuli.

4. The method of claim 1, wherein each node maintains one or more queues of entangled quantum entities aligned to symbolic indices including but not limited to binary, Morse code, alphanumeric letters, and auxiliary application-specific symbols.

5. The method of claim 1, wherein said communication system supports buffered message entry and encoding prior to transmission, with secure erasure upon completion of collapse signaling.

6. The method of claim 1, wherein said entangled entities are stored and maintained under cryogenic or shielded conditions to extend coherence lifetimes.

7. The method of claim 1, wherein said system allows for one-way or two-way collapse-based communication between multiple remote nodes.
